(19) United States
(12) Patent Application Publication
(10) Pub. No.: US 2005/0131979 A1
(43) Pub. Date: Jun. 16, 2005

(54) Apparatus for calculating absolute difference value, and motion estimation apparatus and motion picture encoding apparatus which use the apparatus for calculating the absolute difference value

(75) Inventor: Byung-cheol Song, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/965,753

(22) Filed: Oct. 18, 2004

(30) Foreign Application Priority Data
Dec. 2, 2003 (KR) 2003-86747

(51) Int. Cl. G06F 7/38

(52) U.S. Cl. 708/490

(57) ABSTRACT

An apparatus calculates an absolute difference value, which facilitates an efficient structure of an SAD calculating unit having a tree-like structure, and a motion estimation apparatus and a motion picture encoding apparatus that use the apparatus that calculates the absolute difference value. By performing calculations after inputting carry-outs output from a plurality of pseudo absolute difference calculating units to adders in an adder tree, the number of adders necessary for each absolute difference value calculating unit may be reduced.

### CROSS-REFERENCE TO RELATED APPLICATIONS

This application claims the priority of Korean Patent Application No. 2003-86747, filed on Dec. 2, 2003, in the Korean Intellectual Property Office, the disclosure of which is incorporated herein in its entirety by reference.

### BACKGROUND OF THE INVENTION

1. Field of the Invention

The present invention relates to an apparatus that calculates an absolute difference value and a motion estimation apparatus using the apparatus to calculate the absolute difference value, and more particularly, to an apparatus that calculates an absolute difference value, which facilitates an efficient structure of an absolute difference calculating unit having a tree structure, and a motion estimation apparatus using the apparatus to calculate the absolute difference value.

2. Description of the Related Art

Since digital video recorders (DVR) and personal video recorders (PVR) have recently come into wide use, much research and development of image compression is being conducted. Since conventional DVRs and PVRs compress input images at a fixed resolution regardless of the characteristics of the input images, e.g., temporal complexity, the efficiency of compression is low.

FIG. 1 is a block diagram of a conventional motion picture encoder. Input image data is first divided into blocks of 8×8 pixels. A discrete cosine transform (DCT) unit 110 performs DCT on the input image data that is input in units of 8×8 pixel blocks to remove spatial correlation. A quantization unit 120 performs quantization on DCT coefficients generated by the DCT unit 120 to express the DCT coefficients with several representative values, thus performing high-efficiency low-loss compression. A variable length coding (VLC) unit 130 performs entropy coding on the quantized DCT coefficients and outputs an entropy-coded data stream.

An inverse quantization (IQ) unit 140 performs IQ on the image data quantized by the quantization unit 120. An inverse DCT (IDCT) unit 150 performs IDCT on the image data that is inversely quantized by the IQ unit 140. A frame memory unit 160 stores the image data that is inversely discrete cosine transformed by the IDCT unit 150 in frame units. A motion estimation (ME) unit 170 removes temporal correlation using image data of a current input frame and image data of a previous frame stored in the frame memory unit 160.

A core module of a block-based motion picture encoding like moving picture expert group (MPEG) 2 and MPEG 4 encoding is a motion estimator, i.e., the ME unit 170 of FIG. 1. The ME unit 170 performs the largest amount of computation, but also has a large number of gates due to its complexity when implemented as hardware.

The most frequent calculation performed by such a motion estimator is the calculation of the sum of absolute difference (SAD) of block units. In general, when relatively large images such as MPEG 2 images are handled, a plurality of SADs are simultaneously calculated and compared during one period of a clock signal. Thus, an absolute difference calculator and an adder having a tree-like structure are essential for an SAD calculation.

The encoder shown in FIG. 1 is disclosed in U.S. Pat. No. 6,122,321.

FIG. 2 illustrates a general SAD calculating unit included in the motion estimation unit 170 of FIG. 1, and FIG. 3 illustrates two macroblocks (MB) composed of 16×16 pixels used in an SAD calculation by the SAD calculating unit of FIG. 2. In FIG. 3, the ith pixel of a current MB is denoted by Cᵢ and the ith pixel of a reference MB of a search area having a motion vector with a proper size is denoted by Rᵢ.

Absolute difference calculating units shown in FIG. 2, i.e., |DIFF₀|, |DIFF₁|, |DIFF₂|, |DIFF₃|, . . . , |DIFF₂₅₅|, calculate the differences between absolute values of pixel values Cᵢ of pixels of the current MB, i.e., C₀, C₁, C₂, C₃, . . . , C₂₅₅, and pixel values Rᵢ of pixels of the reference MB, i.e., R₀, R₁, R₂, R₃, . . . , R₂₅₅, respectively. Here, DIFFᵢ denotes Cᵢ−Rᵢ.

Also, the SAD calculating unit of FIG. 2 calculates an absolute difference between two blocks for each pixel using the absolute difference calculating units and calculates an SAD corresponding to a motion vector using an adder tree. Generally, as shown in FIG. 2, if there are 256 absolute difference values, the SAD is calculated using an adder tree.

FIG. 4 illustrates the structure of each of the absolute difference calculating units of FIG. 2. An absolute difference calculating unit, as shown in FIG. 4, is used when the SAD calculating unit has a tree-like structure as shown in FIG. 2 instead of an accumulator structure. Referring to FIG. 4, each of the absolute difference calculating units includes two adders. Thus, to calculate the SAD of a 16×16 MB, the absolute difference calculating units require a total of 256×2, i.e., 512, adders.

As such, since the conventional SAD calculating unit requires at least two adders in each of the absolute difference calculators, a large number of adders are needed and the load of the SAD calculating unit increases.

### SUMMARY OF THE INVENTION

The present invention provides an apparatus that calculates an absolute difference value, which facilitates an efficient structure of an SAD calculating unit by reducing a number of adders in the SAD calculating unit, and a motion estimation apparatus that performs motion estimation using the apparatus to calculate the absolute difference value.

According to one aspect of the present invention, an apparatus that calculates an absolute difference value comprises a plurality of pseudo absolute difference calculating units, an adder tree comprising at least one adder to add output values of the plurality of pseudo absolute difference calculating units, each of the at least one adder receiving one of the signal determining values generated by the plurality of pseudo absolute difference calculating units as a carry-in, and an additional adder adding a final value of the adder tree and a sign determining value generated by one of the plurality of pseudo absolute difference calculating units, thus calculating an absolute difference value.

According to another aspect of the present invention, an apparatus calculating an absolute difference value comprises a plurality of pseudo absolute difference calculating units calculating pseudo absolute differences and a plurality of primary adders, each receiving the pseudo absolute differences calculated by two of the pseudo absolute difference calculating units, using one of the sign determining values created by the plurality of pseudo absolute difference calculating units as a carry-in, and calculating an addition value as a sum of the two pseudo absolute differences.

The apparatus that calculates an absolute difference value may further comprise a secondary adder receiving the addition values calculated by two of the primary adders, using one of the sign determining values generated by the plurality of pseudo absolute difference calculating units and unused by the primary adder, as a carry-in, and calculating an addition value as the sum of the received two addition values. The apparatus may further comprise a third adder that uses the addition value calculated by the secondary adder and one of the sign determining values generated by the plurality of pseudo absolute difference calculating units and unused by the primary adder or the secondary adder, as carry-ins and that calculates an addition value as a sum of the received addition value and the received sign determining value.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a conventional motion picture encoder;

FIG. 2 is a schematic diagram of a conventional SAD calculating unit included in a motion estimation unit 170 of FIG. 1;

FIG. 3 illustrates two 16×16 macroblocks that may be utilized to execute a SAD calculation;

FIG. 4 is a schematic diagram of an absolute difference calculating unit included in the SAD calculating unit of FIG. 2;

FIG. 5 is a schematic diagram of an SAD calculating unit according to a first embodiment of the present invention;

FIG. 6 is a schematic diagram of an SAD calculating unit according to a second embodiment of the present invention; and

FIG. 7 is a schematic diagram of an SAD calculating unit according to a third embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

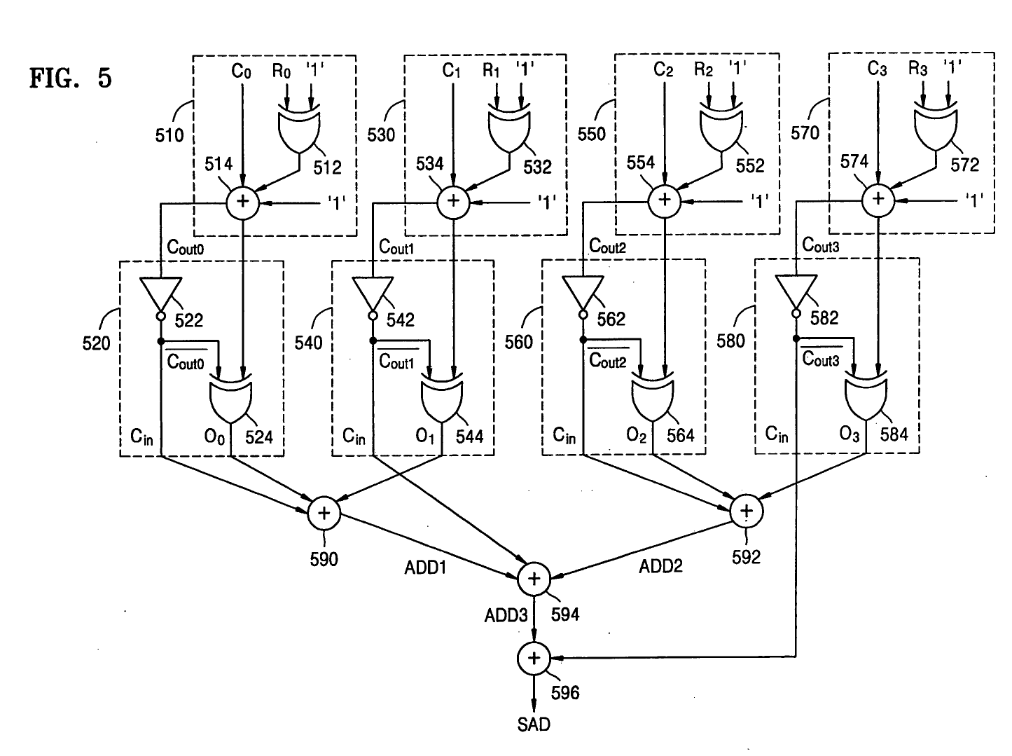

FIG. 5 is a schematic diagram of an SAD calculating unit for 2×2 blocks, according to a first embodiment of the present invention. In the first embodiment of the present invention, an SAD calculating unit for 2×2 blocks is described for convenience of explanation. However, those skilled in the art will understand how to apply the SAD calculating unit to 16×16 blocks.

The SAD calculating unit shown in FIG. 5 includes a first difference value calculating unit 510, a second difference value calculating unit 530, a third difference value calculating unit 550, a fourth difference value calculating unit 570, a first pseudo absolute value calculating unit 520, a second pseudo absolute value calculating unit 540, a third pseudo absolute value calculating unit 560, a fourth pseudo absolute value calculating unit 580, a first adding unit 590, a second adding unit 592, a third adding unit 594, and a fourth adding unit 596.

The first adding unit 590 and the second adding unit 592 are classified as primary adding units, the third adding unit 594 is classified as a secondary adding unit, and the fourth adding unit 596 is classified as a tertiary adding unit.

Also, the first difference value calculating unit 510 and the first pseudo absolute value calculating unit 520 form a first pseudo absolute difference calculating unit, the second difference value calculating unit 530 and the second pseudo absolute value calculating unit 540 form a second pseudo absolute difference calculating unit, the third difference value calculating unit 550 and the third pseudo absolute value calculating unit 560 form a third pseudo absolute difference calculating unit, and the fourth difference value calculating unit 570 and the fourth pseudo absolute value calculating unit 580 form a fourth pseudo absolute difference calculating unit.

The first difference value calculating unit 510 includes an exclusive OR (XOR) gate 512 and an adder 514. A case where pixel values of current and reference blocks each have a resolution of 8 bits will now be described as an example.

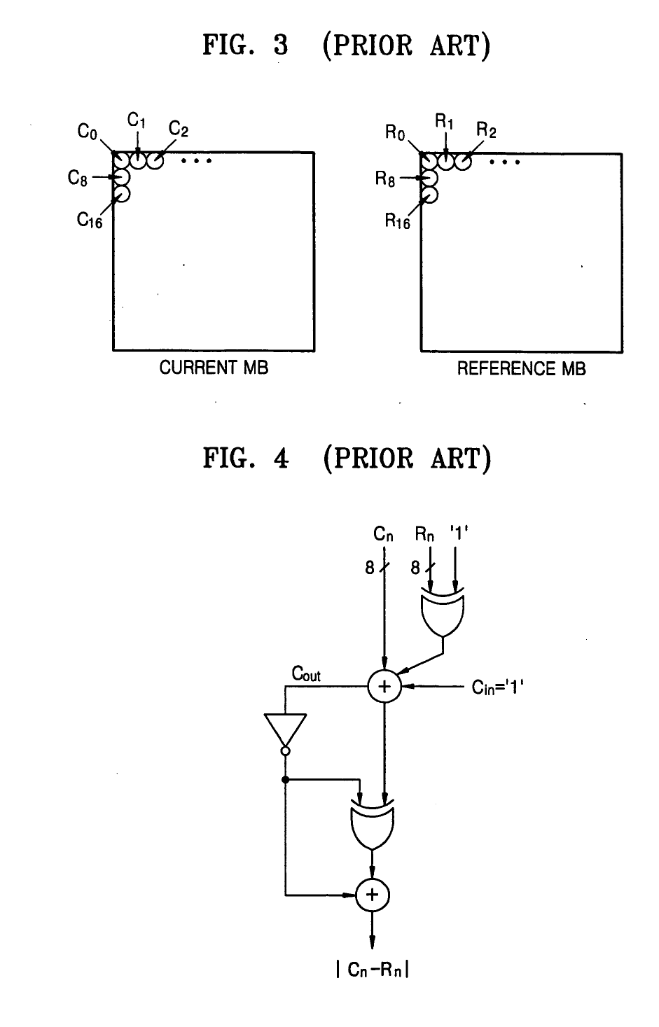

The XOR gate 512 receives a 0th pixel value R₀ of the reference MB shown in FIG. 3 and a carry-in ‘1’ and generates a complement of R₀, i.e., \overline{R₀}.

The adder 514 receives the complement of R₀, i.e., \overline{R₀}, generated by the XOR gate 512, a 0th pixel value C₀ of the current MB shown in FIG. 3, and a carry-in ‘1’ and outputs an output value Z₀=C₀+\overline{R₀}+1 and a carry-out Cₒᵤₜ₀=[256*(C₀+\overline{R₀}+1)/256] In other words, the carry-out Cₒᵤₜ₀ is a most significant bit (MSB) among 9 bits calculated by the adder 514 and serves as a sign bit, i.e., a bit that determines the sign (plus or minus).

The first difference value calculating unit 510 outputs the output value Z₀ and the carry-out Cₒᵤₜ₀.

The first pseudo absolute value calculating unit 520 includes an inverter 522 and an XOR gate 524.

The inverter 522 inverts the carry-out Cₒᵤₜ₀ from the first difference value calculating unit 510 into \overline{Cₒᵤₜ₀} and outputs \overline{Cₒᵤₜ₀} to the XOR gate 524 and the first adding unit 590.

The XOR gate 524 receives \overline{Cₒᵤₜ₀} from the inverter 522 and Z₀=C₀+\overline{R₀}+1 from the adder 514 of the first difference value calculating unit 510 and outputs an output value O₀=Z₀+\overline{Cₒᵤₜ₀}.

In this way, the first pseudo absolute value calculating unit 520 outputs \overline{Cₒᵤₜ₀} and O₀.

The second difference value calculating unit 530 includes an XOR gate 532 and an adder 534. The XOR gate 532 receives a 1st pixel value R₁ of the reference MB shown in FIG. 3 and the carry-in ‘1’ and generates a complement of R₁, i.e., \overline{R₁}.

The adder 534 receives the complement of R₁, i.e., \overline{R₁} created in the XOR gate 532, a 1st pixel value C, of the current MB shown in FIG. 3 and the carry-in ‘1’, and outputs an output value Z₁=C₁+\overline{R₁}+1 and a carry-out Cₒᵤₜ₁=[256*(C₁+\overline{R₁}+1)/256].

In this way, the second difference value calculating unit 530 outputs the output value Z₁ and the carry-out Cₒᵤₜ₁.

The second pseudo absolute value calculating unit 540 includes an inverter 542 and an XOR gate 544. The inverter 542 inverts the carry-out Cₒᵤₜ₁ from the first difference value calculating unit 530 into \overline{Cₒᵤₜ₁} and outputs \overline{Cₒᵤₜ₁} to the XOR gate 544 and the third adding unit 594.

The XOR gate 544 receives \overline{Cₒᵤₜ₁} from the inverter 542 and Z₁=C₁+\overline{R₁}+1 from the adder 534 of the second difference value calculating unit 530 and outputs an output value Q₁=Z₁+\overline{Cₒᵤₜ₁}.

In this way, the second pseudo absolute value calculating unit 540 outputs \overline{Cₒᵤₜ₁} and O₁.

The third difference value calculating unit 550 and the fourth difference value calculating unit 570 perform the same functions as the first difference value calculating unit 510 and the second difference value calculating unit 530, and will not be described in detail.

Also, the third pseudo absolute value calculating unit 560 and the fourth pseudo absolute value calculating unit 580 perform the same functions as those of the first pseudo absolute value calculating unit 520 and the second pseudo absolute value calculating unit 540, and will not be described in detail.

The third absolute value calculating unit 560 outputs an output value \overline{Cₒᵤₜ₂} and O₂ in the same manner as the first pseudo absolute value calculating unit 560.

Also, the fourth absolute value calculating unit 580 outputs an output value \overline{Cₒᵤₜ₃} and O₃ in the same manner as the first pseudo absolute value calculating unit 560. The first adding unit 590 receives the output value O₀ from the first pseudo absolute value calculating unit 520 and the output value O₁ from the second pseudo absolute value calculating unit 540, uses the carry-out \overline{Cₒᵤₜ₀} of the first pseudo absolute value calculating unit 520 as a carry-in, and calculates and outputs a primary addition value ADD1.

The second adding unit 592 receives the output value O₂ from the third pseudo absolute value calculating unit 560 and the output value O₃ from the fourth pseudo absolute value calculating unit 580, uses the carry-out \overline{Cₒᵤₜ₂} of the third pseudo absolute value calculating unit 560 as a carry-in, and calculates and outputs a primary addition value ADD2.

The third adding unit 594 receives the primary addition values ADD1 and ADD2 output from the first adding unit 590 and the second adding unit 592, uses the carry-out \overline{Cₒᵤₜ₁} of the second pseudo absolute value calculating unit 540 as a carry-in, and calculates and outputs a secondary addition value ADD3.

The fourth adding unit 596 receives the secondary addition value ADD3 from the third adding unit 594 and uses the carry-out \overline{Cₒᵤₜ₃} of the fourth pseudo absolute value calculating unit 580 as a carry-in, and calculates and outputs a tertiary addition value.

The tertiary addition value calculated by the fourth adding unit 596 is an SAD of the two 2×2 blocks.

In the first embodiment shown in FIG. 5, the carry-outs \overline{Cₒᵤₜ₀}, \overline{Cₒᵤₜ₁}, \overline{Cₒᵤₜ₂}, and \overline{Cₒᵤₜ₃} output from the pseudo absolute value calculating units 520, 540, 560, and 580 are carried in the adding units 590, 594, 592, and 596, respectively. However, the carry-outs \overline{Cₒᵤₜ₀}, \overline{Cₒᵤₜ₁}, \overline{Cₒᵤₜ₂}, and \overline{Cₒᵤₜ₃} may be respectively input to a desired adding unit.

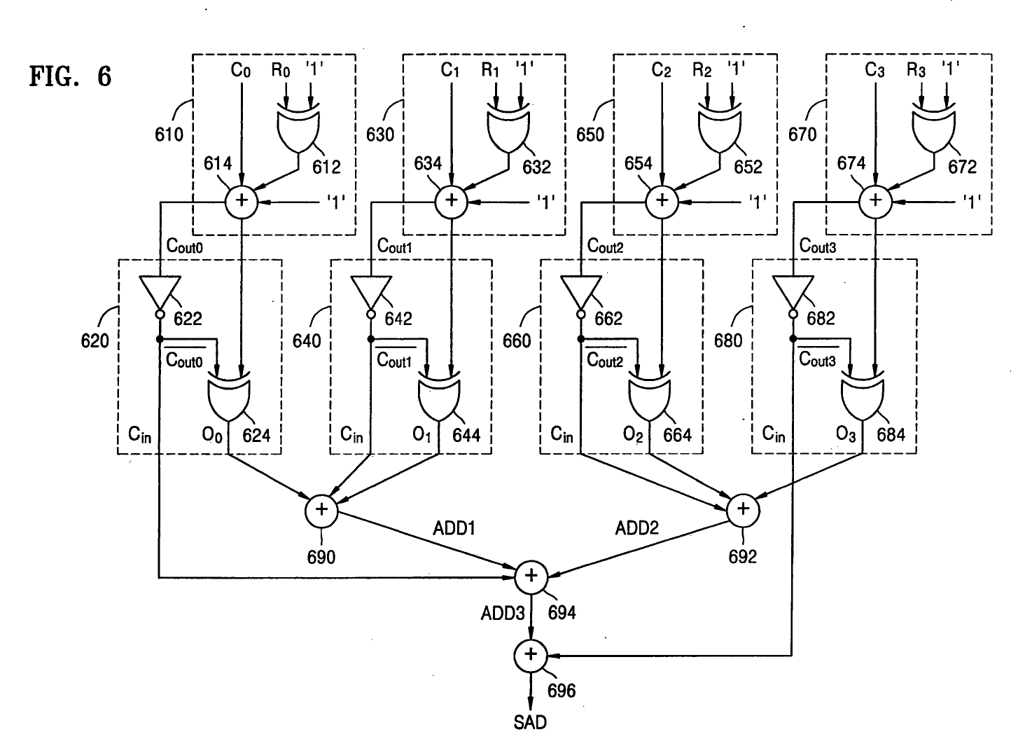

FIG. 6 is a schematic diagram of an SAD calculating unit according to a second embodiment of the present invention. The SAD calculating unit according to the second embodiment of the present invention perform the same functions as the SAD calculating unit according to the first embodiment of the present invention, except that a carry-out \overline{Cₒᵤₜ₀} output from a first pseudo absolute value calculating unit 620 is input to a third adding unit 694 as a carry-in, and a carry-out \overline{Cₒᵤₜ₁} output from a second pseudo absolute value calculating unit 640 is input to a first adding unit 690 as a carry-in. Therefore, for brevity, since other functional parts of the SAD calculating unit according to the second embodiment of the present invention correspond to the similarly numbered units of the first embodiment, the other functional parts of the second embodiment will not be described.

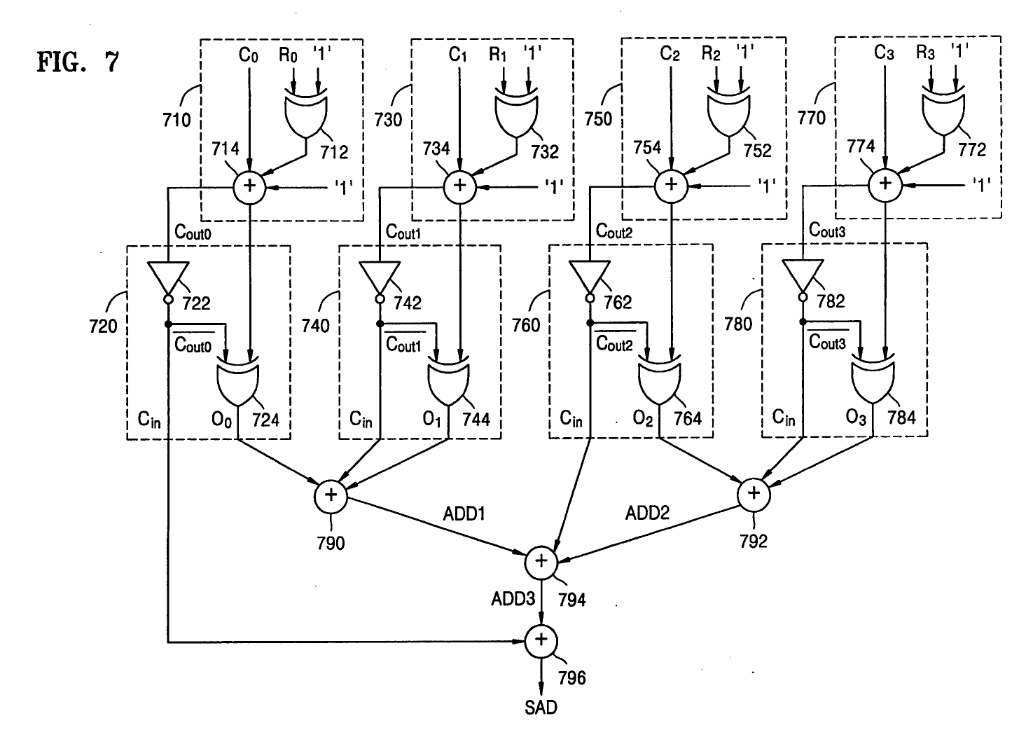

FIG. 7 is a schematic diagram of an SAD calculating unit according to a third embodiment of the present invention. The SAD calculating unit according to the third embodiment of the present invention performs the same functions as the SAD calculating unit according to the first embodiment of the present invention, except that a carry-out \overline{Cₒᵤₜ₀} output from a first pseudo absolute value calculating unit 720 is input to a fourth adding unit 796 as a carry-in, a carry-out \overline{Cₒᵤₜ₁} output from a second pseudo absolute value calculating unit 740 is input to a first adding unit 790 as a carry-in, a carry-out \overline{Cₒᵤₜ₂} output from a third pseudo absolute value calculating unit 760 is input to a third adding unit 794 as a carry-in, and a carry-out \overline{Cₒᵤₜ₃} output from a fourth pseudo absolute value calculating unit 780 is input to a second adding unit 792 as a carry-in. Therefore, for brevity, other functional parts of the SAD calculating unit according to the third embodiment of the present invention will not be described.

As such, in the SAD calculating unit according to embodiments of the present invention, each of carry-outs generated by conventional absolute value calculating units are divisively input to all the adders within an adder tree as carry-ins and used to calculate an SAD. Therefore, the number of adders in absolute difference value calculating units may be reduced.

For example, when an SAD between two 2×2 blocks is calculated, as shown in FIG. 5, 4 carry-outs are output from 4 pseudo absolute value calculating units and three of the 4 carry-outs are input to three adding units 590, 592, and 594 of the adder tree. A result produced by the adder tree and the remaining carry-out are added using an adder, e.g., the fourth adding unit 596. Thus, a final SAD may be obtained. Thus, by connecting one adder to the final adder in the adder tree, the number of adders in absolute value calculating units is reduced by half.

For example, when an SAD between two 2×2 blocks is calculated as shown in FIG. 5, the number of adders may be reduced by 4-1 adders.

In the embodiments of the present invention, calculation of an SAD between two 2×2 blocks is described for convenience of explanation. However, an SAD between two 16×16 blocks may be calculated in the same way.

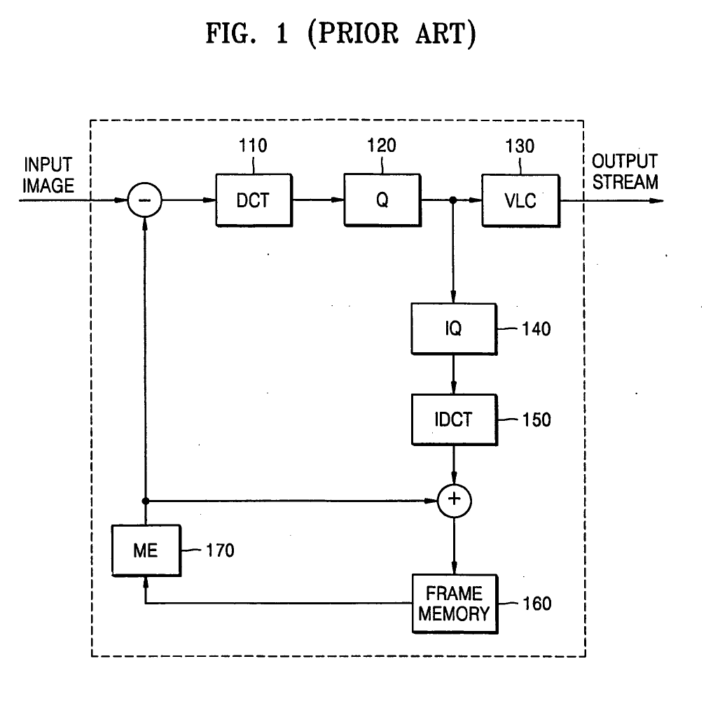

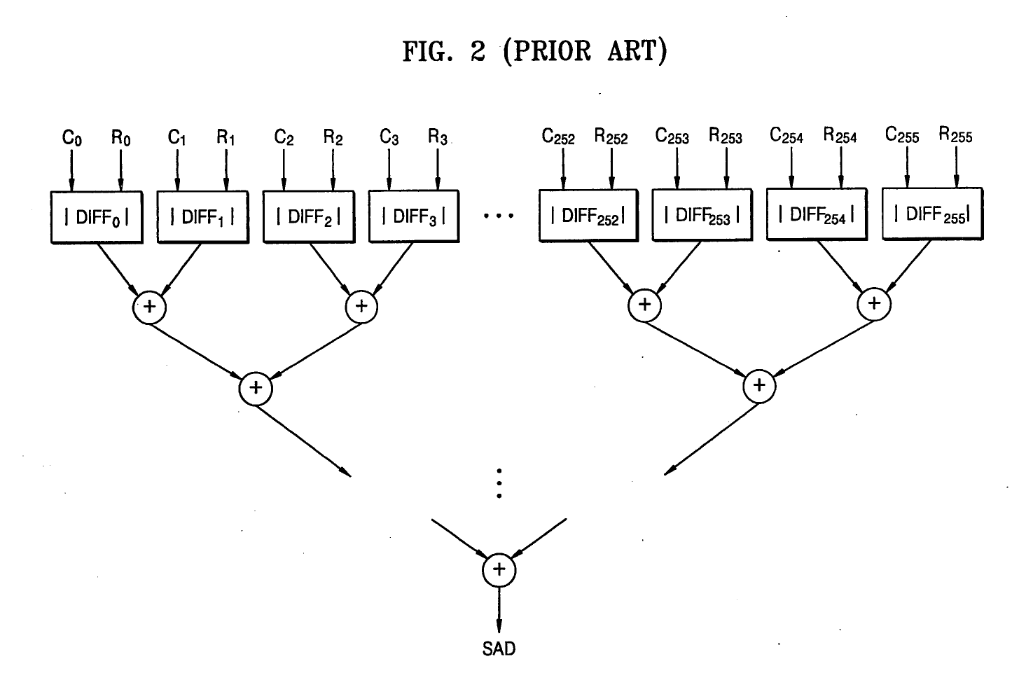

Also, it is possible to reduce the complexity of the hardware by applying the apparatus that calculates an absolute difference value shown in FIG. 5 to the motion estimation unit 170 of the motion picture encoder shown in FIG. 1 or any motion picture encoder.

The present invention may also be embodied as a computer readable code on a computer readable recording medium. The computer readable recording medium may be any data storage device that stores data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium may also be distributed over network coupled computer systems so that the computer readable code is stored and executed in a distributed fashion.

As described above, by calculating an SAD according to an embodiment of the present invention, the number of adders used for calculation of an SAD may be reduced, and the loads of an apparatus that calculates the SAD, a motion estimation apparatus, and a motion picture encoding apparatus may also be reduced.

Although a few embodiments of the present invention have been shown and described, it would be appreciated by those skilled in the art that changes may be made in these embodiments without departing from the principles and spirit of the invention, the scope of which is defined in the claims and their equivalents.

1. An apparatus that calculates an absolute difference value, the apparatus comprising:
a plurality of pseudo absolute difference calculating units;
an adder tree comprising at least one adder to add output values of the plurality of pseudo absolute difference calculating units, each of the at least one adder receiving one of signal determining values generated by the plurality of pseudo absolute difference calculating units as a carry-in; and
an additional adder adding a final value of the adder tree and a sign determining value generated by one of the plurality of pseudo absolute difference calculating units to calculate an absolute difference value.

2. The apparatus of claim 1, wherein each of the sign determining values generated by the plurality of pseudo absolute difference calculating units is input to a different adder.

3. The apparatus of claim 1, wherein each of the pseudo absolute difference calculating units comprises:
a difference value calculating unit calculating a difference value equal to a difference between two input values; and
a pseudo absolute value calculating unit including an inverter inverting a carry-out of the difference value calculating unit and an XOR gate XORing an inverted value and a value output from the difference value calculating unit and outputting a result of XORing.

4. The apparatus of claim 3, wherein the carry-out is a most significant bit of the difference value calculated by the difference value calculating unit and the sign determining value is an inversion of the most significant bit.

5. The apparatus of claim 3, wherein the output value of each of the pseudo absolute difference calculating units is the XOR value.

6. A motion estimation apparatus that performs motion estimation using the apparatus that calculates an absolute difference value of claim 1.

7. A motion picture encoding apparatus that performs motion picture encoding using the motion estimation apparatus of claim 6.

8. An apparatus calculating an absolute difference value, the apparatus comprising:
a plurality of pseudo absolute difference calculating units calculating pseudo absolute differences; and
a plurality of primary adders, each receiving the pseudo absolute differences calculated by two of the pseudo absolute difference calculating units, using one of sign determining values created by the plurality of pseudo absolute difference calculating units as a carry-in, and calculating an addition value as a sum of the two pseudo absolute differences.

9. The apparatus of claim 8, further comprising a secondary adder receiving the addition values calculated by two of the primary adders, using one of the sign determining values generated by the plurality of pseudo absolute difference calculating units and unused by the primary adder, as a carry-in, and calculating an addition value as the sum of the received two addition values.

10. The apparatus of claim 9, further comprising a third adder that uses the addition value calculated by the secondary adder and one of the sign determining values generated by the plurality of pseudo absolute difference calculating units and unused by the primary adder or the secondary adder, as carry-ins and calculates an addition value as the sum of the received addition value and the received sign determining value.

11. The apparatus of claim 8, wherein each of the pseudo absolute difference calculating units comprises:
a difference value calculating unit calculating a difference value equal to a difference between two input values; and
a pseudo absolute value calculating unit comprising an inverter inverting a carry-out of the difference value calculating unit and an XOR gate XORing an inverted value and a value output from the difference value calculating unit and outputting a result of XORing value.

12. The apparatus of claim 11, wherein the carry-out is a most significant bit of the difference value calculated by the difference value calculating unit and the sign determining value is an inversion of the most significant bit.

13. The apparatus of claim 11, wherein an output value of each of the pseudo absolute difference calculating unit is the XOR value.

14. A motion estimation apparatus that performs motion estimation using the apparatus to calculate an absolute difference value of claim 8.

15. A motion picture encoding apparatus that performs motion picture encoding using the motion estimation apparatus of claim 14.

16. A computer-readable medium having embodied thereon computer-readable code to calculate an absolute difference value, the computer readable code comprising instructions to:
determine a plurality of pseudo absolute differences using a plurality of pseudo absolute difference calculating units;
use an adder tree comprising at least one adder to add output values of the plurality of pseudo absolute difference calculating units, each of the at least one adder receiving one of signal determining values generated by the plurality of pseudo absolute difference calculating units as a carry-in; and
add, using an additional adder unit, a final value of the adder tree and a sign determining value generated by one of the plurality of pseudo absolute difference calculating units to calculate an absolute difference value.

17. The computer-readable medium of claim 16, wherein the computer readable code includes instructions to input, to a different adder unit, each of the sign determining values generated by the plurality of pseudo absolute difference calculating units.

18. The computer-readable medium of claim 16, wherein each of the pseudo absolute difference calculating units comprises computer instructions to:
calculate a difference value equal to a difference between two input values; and
determine a pseudo absolute value, including using an inverter to invert a carry-out of the difference value, using an XOR gate unit to XOR an inverted value and a value output from the difference value, and outputting a result of the XORing.

19. The computer-readable medium of claim 18, wherein the carry-out is a most significant bit of the difference value and the sign determining value is an inversion of a most significant bit.

20. The computer-readable medium of claim 18, wherein an output value of each of the pseudo absolute difference values is an XOR value.

21. A computer-readable medium having embodied thereon computer-readable code to calculate an absolute difference value, the computer readable code comprising instructions to:
utilize a plurality of pseudo absolute difference calculating units to calculate pseudo absolute differences; and
implement a plurality of primary adders, each receiving the pseudo absolute differences calculated by two of the pseudo absolute difference calculating units, using one of sign determining values created by the plurality of pseudo absolute difference calculating units as a carry-in, and calculating an addition value as a sum of the two pseudo absolute differences.

22. The computer-readable medium of claim 21, further comprising computer instructions to implement a secondary adder unit to receive the addition values calculated by two of the primary adders, use one of the sign determining values generated by the plurality of pseudo absolute difference calculating units and unused by the primary adder, as a carry-in, and calculate an addition value as a sum of the received two addition values.

23. The computer-readable medium of claim 21, further comprising computer instructions to implement a third adder to use the addition value calculated by the secondary adder and one of the sign determining values generated by the plurality of pseudo absolute difference calculating units and unused by the primary adder or the secondary adder, as carry-ins and to calculate an addition value as a sum of the received addition value and the received sign determining value.

24. The computer-readable medium of claim 21, wherein each of the pseudo absolute difference calculating units comprises computer instructions to:
use a difference value calculating unit to calculate a difference value equal to a difference between two input values; and
implement a pseudo absolute value calculating unit comprising an inverter inverting a carry-out of the difference value calculating unit and an XOR gate XORing an inverted value and a value output from the difference value calculating unit and outputting a result of the XORing.

25. The computer-readable medium of claim 24, wherein the carry-out is a most significant bit of the difference value calculated by the difference value calculating unit and the sign determining value is an inversion of the most significant bit.

26. The computer-readable medium of claim 24, wherein an output value of each of the pseudo absolute difference calculating unit is an XOR value.

27. The apparatus of claim 1, wherein the adders comprise a first adding unit, a second adding unit, a third adding unit and a fourth adding unit and each of the pseudo absolute difference calculating units comprises:
a difference value calculating unit calculating a difference value equal to a difference between two input values; and
a first pseudo absolute value calculating unit having a carry-out output that is input into the fourth adding unit as a carry-in;
a second pseudo absolute value calculating unit having a carry-out that is input to the first adding unit as a carry-in;
a third pseudo absolute value calculating unit having a carry-out that is input to the third adding unit as a carry-in; and
a fourth pseudo absolute value calculating unit having a carry-out that is input to the second adding unit as a carry-in.

28. The apparatus of claim 27, wherein the carry-out is a most significant bit of the difference value calculated by the difference value calculating unit and the sign determining value is an inversion of the most significant bit.

29. The computer medium of claim 16, wherein the adders comprise a first adding unit, a second adding unit, a third adding unit and a fourth adding unit and each of the pseudo absolute difference calculating units comprises computer instructions to:
use a difference value calculating unit to calculate a difference value equal to a difference between two input values; and
implement a first pseudo absolute value calculating unit having a carry-out output that is input into the fourth adding unit as a carry-in;
implement a second pseudo absolute value calculating unit having a carry-out that is input to the first adding unit as a carry-in;
implement a third pseudo absolute value calculating unit having a carry-out that is input to the third adding unit as a carry-in; and
implement a fourth pseudo absolute value calculating unit having a carry-out that is input to the second adding unit as a carry-in.

30. The computer medium of claim 29, wherein the carry-out is a most significant bit of the difference value calculated by the difference value calculating unit and the sign determining value is an inversion of the most significant bit.
